(19) United States
(12) Patent Application Publication
(10) Pub. No.: US 2012/0091269 A1
(43) Pub. Date: Apr. 19, 2012

(54) LIGHTNING STRIKE PROTECTION IN AIRCRAFT

(75) Inventors: José Ignacio López-Reina Torrijos, Madrid (ES); César Bautista De La Llave, Madrid (ES)

(73) Assignee: AIRBUS OPERATIONS, S.L.

(21) Appl. No.: 13/015,913

(22) Filed: Jan. 28, 2011

(30) Foreign Application Priority Data
Oct. 13, 2010 (ES) 201031511

(51) Int. Cl. B64D 45/02

(52) U.S. Cl. 244/1 A

(57) ABSTRACT

Lightning strike protection in aircraft: the invention refers to a lightning strike protection system for fuel tank access covers (10) in composite structures having a skin (30), this system comprising an outer cover (12) made of metallic material, that coats externally the fuel tank access covers (10) and an inner cover (13) made of composite material, the outer cover (12) also comprising a lip element (14), made of the same metallic material than that of the outer cover (12) and being integrated in its structure, and a conductive visco-elastic material or spring element (15) provided over the mentioned lip element (14).

### FIELD OF THE INVENTION

The present invention relates to a lightning strike protection system for fuel tank access covers in aircraft structure wing skins.

### BACKGROUND OF THE INVENTION

Aircraft wings are usually provided with openings in order to access the inner part of the wing box, where fuel tanks are placed. These openings need to have dimensions such as to allow a person get access to the wing box: this is why the openings are usually called manholes, these manholes being usually located in the lower skins of the aircraft wings. The access into the aircraft wing box is required, both during the wing assembly process and the aircraft operation along its service life for maintenance tasks of the aircraft.

Manholes made in aircraft wings are necessarily provided with covers, that comprise removable covers closing the manhole openings. These covers need to be fuel tight, as well as to form part of the aerodynamic surface of the lower skin part of the wings where the manholes are located, and need to protect the fuel tank from all kind of likely threads, such as impacts, lightning strike, fire, etc. Additionally, fuel tank access covers in aircraft are designed not to carry load capability, as they do not contribute to carry out flight, neither ground, wing covers loads. Thus, these manhole covers are only requested to keep aerodynamic requirements (flush with aerodynamic contour) and to withstand fuel pressure loads and external impacts from different objects (called foreign object impacts), such as runway debris, tire debris, engine small fragments (UERF), etc.

At present, composite materials are used more and more frequently in aircraft structures, and also in aircraft wings. These materials are sensitive to high temperatures and hot spots, specially coming from lightning strikes, because of the low melting temperature of the resin used in said materials. Therefore, in composite design, in order to keep the damage produced by a lightning strike within allowable limits (with no capability of degradation of structural components), and preventing hazardous ignition source (can be sparking, arcing and/or hot spot) within the fuel tanks area, it is mandatory to have in these composite structures a lightning strike protection system, that typically consists in a metallic conductive mesh embedded in the composite laminate externally. The outer surface surrounding an access manhole in aircraft wings requires surface protection, such that this surface is made conductive, thus providing lightning strike protection, which will be appropriate to the lightning zone and the type of threat applicable in which the manhole is located.

Typically in the prior art, manhole covers comprise two closing parts or doors that, when brought together, by screwing, clamp onto the wing skin. The external door is usually made in metal in order to shield and prevent door breakage from high energy impacts. The inner door can be made of composite material, and provides the required stiffness to support the fuel tank pressure, having the clamping capability to be attached to the wing skin. When a manhole is machined in a wing skin, made from composite material and comprises an embedded metallic mesh for lightning strike protection, this mesh is damaged in many occasions, and has to be restored in order to keep electrical bonding between the external metallic cover and the metallic mesh. Such operation is hard, cost and time consuming. Typically, the inner door in the manhole cover is electrically isolated from the wing skin, in order to prevent possible sparking into the fuel tank due to the lightning current flowing to the inner surfaces.

Therefore, it shall be desirable to provide manhole covers in aircraft wings accessing fuel tanks splitting two functionalities: keeping the mechanical attachment between the fuel tank access cover and the skin, and keeping the electrical bonding between external fuel tank access cover and the skin lightning strike protection mesh For both objects, it shall be desirable to provide manhole covers that decouple both functionalities.

The present invention provides a solution to the afore-mentioned problems.

### SUMMARY OF THE INVENTION

It is an object of the present invention to provide a lightning strike protection system in manholes made in aircraft wings to access fuel tanks, these manholes being made in the lower skin of the aircraft wings, the skin being made in composite material and comprising a metallic mesh embedded in its structure.

The object of the invention is therefore to provide manhole covers presenting lightning strike protection and imparting two functionalities: the manhole covers are clamped to the wing lower skin, and provide an electrical bonding between their outer covers and the metallic mesh embedded in the outer area of the skin, such that the mentioned functionalities are decoupled one from the other. The Lightning strike protection system of the invention would prevent current flowing to the inner fuel tank surfaces.

The lightning strike protection system provided for fuel tank access covers of the invention comprise an outer cover made of metallic material, that coats externally the manhole, and an inner cover made of composite material. The outer cover of the invention also comprises a lip element, integrated in the same metallic material of the outer cover, and a conductive visco-elastic material or metallic spring provided over the mentioned lip element. This arrangement makes possible that the outer cover contacts the outer metallic mesh embedded in the skin of composite material, such that this contact is made in a tight manner, providing a continuous electrical bonding between the skin and the manhole cover.

The outer cover of the manhole covers of the invention also comprise an electrically isolating gasket, covering the internal area where the outer cover contacts the skin made of composite material. The isolating gasket assures that the electrical bonding is kept between the outer cover lip element and the metallic mesh embedded in the wing skin.

Also, according to the invention, the fuel tank access covers and the access hole in the skin are designed in order to keep a controlled (Tolerance Analysis) gap target between the outer cover lip element and the wing skin. Such gap is closed by the visco-elastic material or metallic spring providing the required adjustment of compressibility between said elements (fuel tank access cover tightening) and adjusting them in a conductive manner.

Other characteristics and advantages of the present invention will be clear from the following detailed description of embodiments illustrative of its object in relation to the attached figures.

### DESCRIPTION OF THE DRAWINGS

FIG. 1 is a section view showing the detail of machined manhole covers in aircraft wing skins made of composite material, as known in the prior art.

FIGS. 2a and 2b provide views in detail of the lightning strike protection system for fuel tank access covers in aircraft, and of access holes according to the invention.

### DETAILED DESCRIPTION OF THE INVENTION

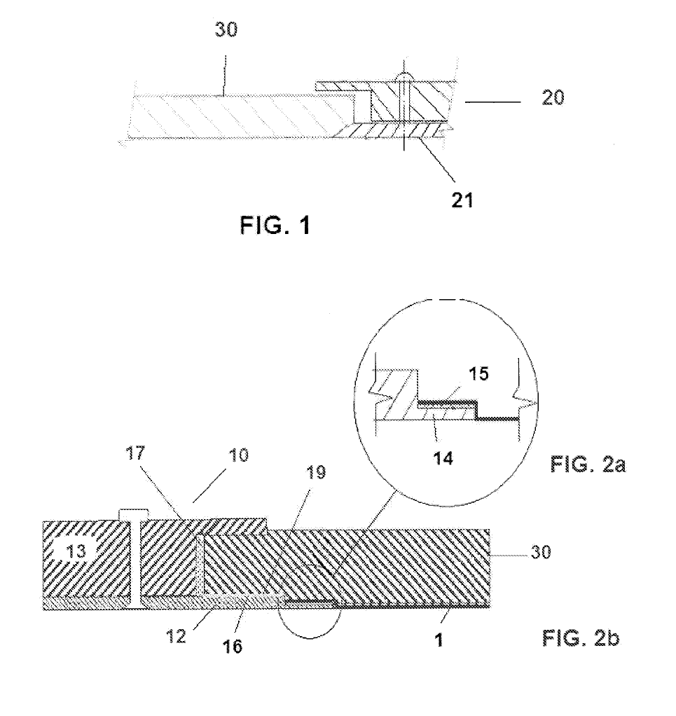

FIG. 1 shows manhole covers according to the prior art, in which mechanical tightness and electrical bonding are obtained by machining the wing skin. However, the problem of these systems is that the manufacturing costs and timings are very high and, at the same time, the metallic mesh embedded in the outer skin 30 of the aircraft is damaged, therefore preventing an effective electrical bonding between the manhole outer covers 21 and the skin 30, which is essential for avoiding sparking.

It is an object of the present invention to provide a lightning strike protection system in manholes made in aircraft wings to access fuel tanks (called fuel tank access covers 10), these manholes being made in the lower skin 30 of the aircraft wings, the skin 30 being made in composite material and comprising a metallic mesh 1 embedded in its structure. Mesh density will depend on the lightning threat applicable and on the design concept as well (type of CFRP, thickness, etc.).

The fuel tank access covers or manhole covers 10 of the invention comprise an outer cover 12 made of metallic material, that coats externally the manhole, and an inner cover 13 made of composite material. The outer cover 12 also comprises a lip element 14, made of the same metallic material than that of the outer cover 12 and being integrated in its structure, and a conductive visco-elastic element 15 (it can also be a metallic spring element) provided over the mentioned lip element 14 (see FIGS. 2a and 2b). This arrangement makes possible that the outer cover 12 contacts the outer metallic mesh 1 embedded in the skin 30 of composite material in the aircraft wing, such that this contact is made through the visco-elastic material or metallic spring 15, providing a continuous electrical bonding between the skin 30 and the manhole cover 10.

The outer cover 12 of the manhole covers 10 of the invention also comprises an electrically isolating gasket 16, covering the internal area where the outer cover 12 contacts the skin 30 made of composite material (see FIG. 2a). The isolating gasket 16 assures that the electrical bonding is kept between the outer cover 12 of metallic material and the metallic mesh 1 in the outer part of the aircraft skin 30. The mechanical attachment of the fuel tank access cover 10 is provided by the clamping forces of screwing between contact surfaces of the outer cover 12 and wing skin 30 at a machined area 19 (see FIG. 2b).

The manhole covers 10 of the invention also comprise a gap 17 (FIG. 2b) which is continuously maintained between the inner cover 13 of the manhole cover 10 and the skin 30.

The thickness of the skin 30 is enough to withstand high energy impacts without fuel leakage. In a similar way, outer covers 12 should be designed in metal, preferably in titanium or in steel, to prevent foreign object penetration into the fuel tank. Any impact in the outer cover 12 of the fuel tank access cover 10 is absorbed by plastic deformation of the metal of said outer cover 12, being the produced forces reacted by the composite material of the skin 30.

The inner cover 13 is clamped to the skin 30, withstanding the fuel pressure and reacting the pressure load to the wing skin 30 by mechanical contact (FIG. 2a).

In order to prevent sparking between the metallic outer cover 12 and the metallic mesh 1 in the skin 30, it is necessary to have electrical bonding between both parts. This is achieved by means of the lip element 14, made in the outer cover 12, this lip element 14 being made around the whole perimeter of the outer cover 12.

The lip element 14 has a thickness of preferably less than 2 mm, being made in the outer cover 12.

The conductive visco-elastic material or metallic spring 15 provided over the lip element 14, is sized to absorb the interface tolerances in the mechanical contact of the outer cover 12 against the skin 30, keeping at the same time the electrical contact between the lip element 14 and the external mesh 1 in the skin 30.

As redundant protection layer, the electrically isolating gasket 16 is provided in the outer cover 12. The electrically isolating gasket 16 is preferably a bead of resin, adhesive or plastic isolating material added in the inner surface of the outer cover 12 contacting a machined area 19 in the composite laminate of the skin 30, in order to avoid sparking or electrical discharge in the mentioned area (FIGS. 2a and 2b).

Although the present invention has been fully described in connection with preferred embodiments, it is evident that modifications may be introduced within the scope thereof, not considering this as limited by these embodiments, but by the contents of the following claims.

1. Lightning strike protection system for fuel tank access covers (10) in composite structures having a skin (30), this system comprising an outer cover (12) made of metallic material, that coats externally the fuel tank access covers (10) and an inner cover (13) made of composite material, the outer cover (12) also comprising a lip element (14), made of the same metallic material than that of the outer cover (12) and being integrated in its structure, and a conductive visco-elastic material or spring element (15) provided over the mentioned lip element (14).

2. Lightning strike protection system according to claim 1, wherein the outer cover (12) comprises an electrically isolating gasket (16), covering the internal area where the outer cover (12) contacts the skin (30) in composite material, the electrically isolating gasket (16) being made of composite material.

3. Lightning strike protection system according to claim 1, wherein the fuel tank access covers (10) also comprise a gap (17) which is continuously maintained between the inner cover (13) and the skin (30).

4. Lightning strike protection system according to claim 1, wherein the lip element (14) has a thickness of around 2 mm.

5. Lightning strike protection system according to claim 1 wherein the system is used in manholes made in aircraft wings to access fuel tanks, these manholes being made in the lower skin (30) of the aircraft wings, the skin (30) being made in composite material and comprising a metallic mesh (1) embedded in its structure.

6. Lightning strike protection system according to claim 5, wherein the thickness of the skin (30) is sized to withstand the stress in flight and during ground loading.

7. Lightning strike protection system according to claim 5, wherein the outer cover (12) is designed in metal, preventing foreign object penetration into the fuel tank.

8. Lightning strike protection system according to claim 5, wherein the electrically isolating gasket (16) is a bead of resin, adhesive or plastic isolating material.

9. Lightning strike protection system according to claim 8 wherein the electrically isolating gasket (16) is made in the inner surface of the outer cover (12) contacting a machined edge (19) made in the skin (30).
